(19) United States
(12) Patent Application Publication
(10) Pub. No.: US 2012/0254142 A1
(43) Pub. Date: Oct. 4, 2012

(54) INFORMATION DISPLAY METHOD AND SYSTEM EMPLOYING SAME

(75) Inventors: NANCY KNOWLTON, Calgary (CA); DOUGLAS B. HILL, Calgary (CA)

(73) Assignee: SMART TECHNOLOGIES ULC, Calgary (CA)

(21) Appl. No.: 13/077,658

(22) Filed: Mar. 31, 2011

(51) Int. Cl. G06F 17/30

(52) U.S. Cl. 707/705; 707/E17.001

(57) ABSTRACT

An information display method comprises retrieving, from at least one database, the information concerning a user and at least one other user, calculating a relationship value for the at least one other user, the relationship value being at least partly based on the retrieved information and using the relationship value as a factor during the display of information relating to the user and the at least one other user.

### FIELD OF THE INVENTION

The present invention relates to an information display method and system employing the same.

### BACKGROUND OF THE INVENTION

Technologies that allow users to search for people as well as to obtain information concerning located people are well known. For example, social networking websites and tools such as Facebook®, LinkedIn®, Skype®, Microsoft® Windows Live™ Spaces and Microsoft® Live Messenger allow users to create and store profiles on service providers' servers, and make at least some of their profile information available to other people. As a result, users are able to search for people, obtain their accessible profile information, and if desired, add them to their contact lists.

U.S. Pat. No. 7,545,784 to Mgrdechian et al. discloses a communication method for wireless communication between previously known and unknown users. A first wireless device receives the device identifications (IDs) associated with other wireless devices, and transmits the device IDs, via a cellular network, to a remote computer. The remote computer, after receiving the device IDs, accesses information associated with the device IDs, and sends the information to the first wireless device.

U.S. Patent Application Publication No. 2008/0201076 to Huang et al. discloses a witness based tracking system and method which includes a first mobile sensor module and a second mobile sensor module. The mobile sensor modules may be carried, worn or attached to hikers, skies, and climbers who participate in activities mainly in remote areas. When a mobile sensor module encounters another mobile sensor module and is within communication range of that other mobile sensor module, a witness event including mobile ID, time and location of encounter is recorded and stored in the mobile sensor modules. Stored witness events are transmitted to an access point and sent to a data processing center via the access point for storage in a database. The witness events stored within the database are processed to determine a last encounter of one or both of the mobiles sensor modules.

U.S. Patent Application Publication No. 2008/0146157 to Aaron discloses a system and method for recording personal encounter history using a communication device. The method involves the communication device receiving a proximal pseudo identifier from a proximal communication device of an encounter where the pseudo identifier is associated with the user of the proximal communication device. The communication device includes a memory device, a processor and a transceiver capable of communicating wirelessly with a mobile telecommunications network. The communication device is capable of receiving the actual identification/contact information correlated with the proximal pseudo identifier from a server. The encounter time and location are also stamped and saved into a local database until uploaded to a central server.

While the above-described technologies allow users to obtain information concerning individuals, they provide limited functionality. It is therefore an object of the following to provide a novel information display method and system employing the same.

### SUMMARY OF THE INVENTION

Accordingly, in one aspect there is provided an information display method comprising retrieving, from at least one database, information concerning a user and at least one other user; calculating a relationship value for the at least one other user, the relationship value being at least partly based on the retrieved information; and using the relationship value as a factor during the display of information relating to the user and the at least one other user.

In one embodiment, the relationship value is used to determine the position of displayed information relating to the user and the at least one other user and in particular the relative positions of display elements representing the user and the at least one user. The relationship value is at least partly based on the frequency of communications between the user and at least one other user, at least partly based on commonalities and/or similarities between the user and the at least one other user and one or more of a user designated adjustment factor and weighting factors. The commonalities and/or similarities are commonalities and/or similarities in social attributes of the user and the at least one other user. The commonalities and/or similarities in social attributes are determined by comparing corresponding social attribute fields in profiles of the user and at least one other user stored in the at least one database.

In one embodiment, when the relationship value is representative of a strong relationship between the user and the at least one other user, the display elements representing the user and the at least one other user are positioned proximate to one other. When the relationship value is representative of a weak relationship between the user and the at least one other user, the display elements representing the user and the at least one other user are positioned away from one another. The display elements representing the user and the at least one other user are presented on a social map with at least the display element representing the at least one other user being manipulatable in response to user input. When the display element representing the at least one other user is moved relative to the display element representing the user in response to user input, the relationship value is recalculated based on the new relative positions of the display elements. The social map may be partitioned into at least two zones based on defined groups. The zone in which the display element representing the at least one other user is located, is based on group data assigned to the at least one other user.

According to another aspect there is provided an apparatus comprising an apparatus comprising memory; and processing structure communicating with the memory, the processing structure, executing program code stored in the memory, to cause the apparatus to retrieve, from at least one database, information concerning a user and at least one other user; instruct calculation of a relationship value for the at least one other user, the relationship value being at least partly based on the retrieved information; and use the relationship value as a factor during the display of information relating to the user and the at least one other user.

According to yet another aspect there is provided a method comprising a server configured to receive, from at least one database, information concerning a user and at least one other user, calculate a relationship value for the at least one other user with the relationship value being at least partly based on the retrieved information and transmit the calculated relationship value to a portable computing device for use as a factor during the display of information relating to the user and the at least one other user on the portable computing device.

### BRIEF DESCRIPTION OF THE DRAWINGS

Embodiments will now be described more fully with reference to the accompanying drawings in which:

FIG. 1 is a schematic diagram of a user identity detection system;

FIG. 2 illustrates the system architecture of the user identity detection system of FIG. 1;

FIG. 3 illustrates a user profile structure;

FIG. 4 is a flowchart showing the steps performed on a portable computing device for determining a social metric;

FIG. 5A illustrates a user interface (UI) displayed on a portable computing device showing the profiles of detected users;

FIG. 5B illustrates an alternative UI displayed on a portable computing device showing the profiles of detected users;

FIG. 6 illustrates a UI for editing the user profile of an unknown user;

FIG. 7 shows a UI for customizing the calculation of a social metric;

FIG. 8 shows a UI for customizing the display of detected users;

FIG. 9A is a schematic diagram of an alternative user identity detection system;

FIG. 9B is a flowchart showing the steps performed by the user identity detection system of FIG. 9A during determination of a social metric.

FIG. 10 illustrates a UI of a portable computing device showing a social map;

FIG. 11 illustrates a UI showing the floor plan of a site; and

FIG. 12 illustrates a UI of a portable computing device for adjusting the accuracy of location information of a user to be disclosed.

### DETAILED DESCRIPTION OF THE EMBODIMENTS

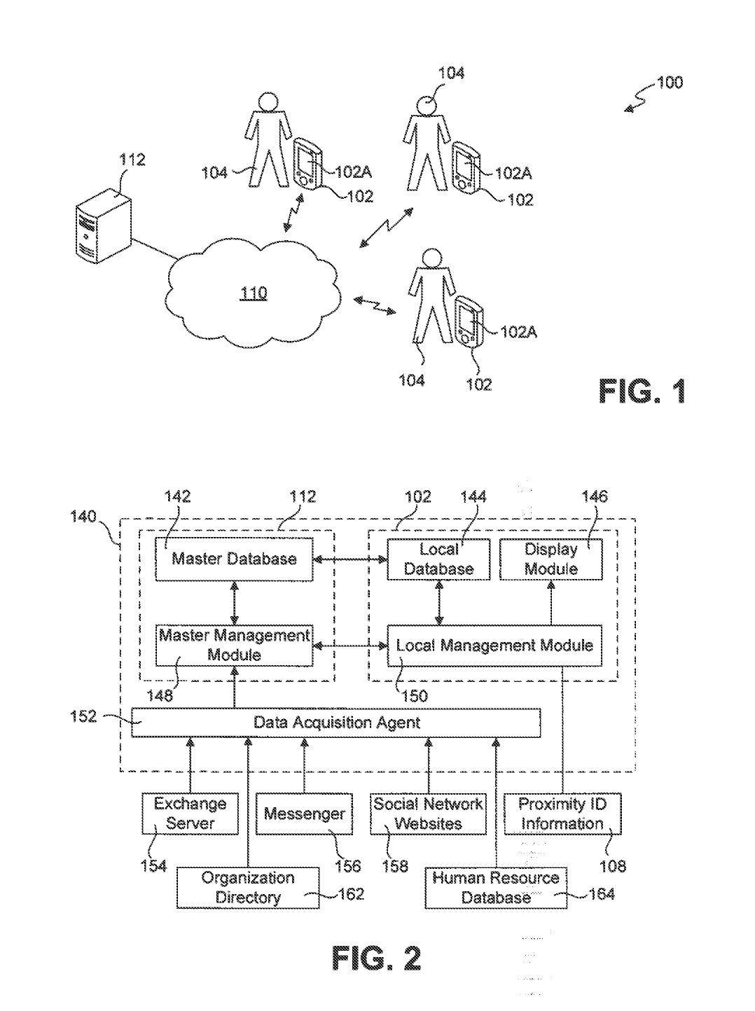

Turning now to FIG. 1, a user identity detection system is shown and is generally identified by reference numeral 100. In this embodiment, user identity detection system 100 comprises a plurality of portable computing devices 102, each of which is associated with a respective user 104. Although only three (3) portable computing devices 102 and associated users 104 are shown, those of skill in the art will appreciate that this is for ease of illustration only. Typically, user identity detection system 100 will comprise more than three (3) portable computing devices 102, although the user identity detection system 100 may comprise fewer portable computer devices 102 if desired. Each portable computing device 102 is wirelessly connected to a network 110 such as for example, a WiFi, WLAN, Intranet, Internet, cellular network or the like. A server 112 is also connected to the network 110.

The portable computing devices 102 may take a variety of forms. For example, each portable computing device 102 may be one of a smartphone, personal digital assistant (PDA), tablet or laptop personal computer (PC) or the like. In this embodiment, each portable computing device 102 comprises a processing unit, memory (volatile and/or non-volatile memory), a system bus coupling the memory and processing unit and a touch sensitive display screen 102A that displays a graphic user interface (GUI) and receives user input as a result of user interaction with the touch sensitive display screen 102A. Each portable computing device 102 also comprises an identity detector (not shown) to detect the identities of other portable computing devices 102 that are within a communication range. In this embodiment, the identity detector of each portable computing device 102 is a Bluetooth device, which is configured to detect the Bluetooth devices of other portable computing devices 102. The Bluetooth device of each portable computing device 102 searches for other Bluetooth devices that are in a discoverable mode, and requests discovered Bluetooth devices to respond with, among other information, their Bluetooth address and their class of device record. The Bluetooth address is used in this embodiment as a portable computing device identification (ID). Each portable computing device ID is associated with a user ID, that is unique to the user 104 associated with the portable computing device 102.

FIG. 2 shows the architecture 140 of the user identity detection system 100. As can be seen, server 112 comprises a master database 142, a master management module 148 that communicates with the master database 142 and a data acquisition agent 152 that communicates with the master management module 148. The data acquisition agent 152 is configured to acquire user related data from various sources accessible via the network 110. These sources may include for example an email and scheduling server 154 (e.g., Microsoft® Exchange server), an organization directory 162, instant messengers 156 (e.g., Skype®, Microsoft® Live Messenger, Yahoo!® Messenger, etc.), social networking websites 158 (e.g., Facebook®, Microsoft® Live Spaces, etc.), a human resource database 164 of an organization, etc.

A variety of user related data from the various sources may be acquired by the data acquisition agent 152, such as for example user name, gender, age, job title, department and organization of employment, phone numbers, email addresses, professional skills, former employers, working background, educational background, hobbies, and contact lists stored in instant messengers or social networking websites, etc. Upon verification of proper access right and privacy settings, the user related data may be automatically acquired by the data acquisition agent 152, e.g., from the Exchange server 154, automatically exported from, e.g., a user's account at a social networking website 158 to the data acquisition agent 152, or manually input to the data acquisition agent 152 by a user. The technology for acquiring such data is well known in the art and will not be further described herein.

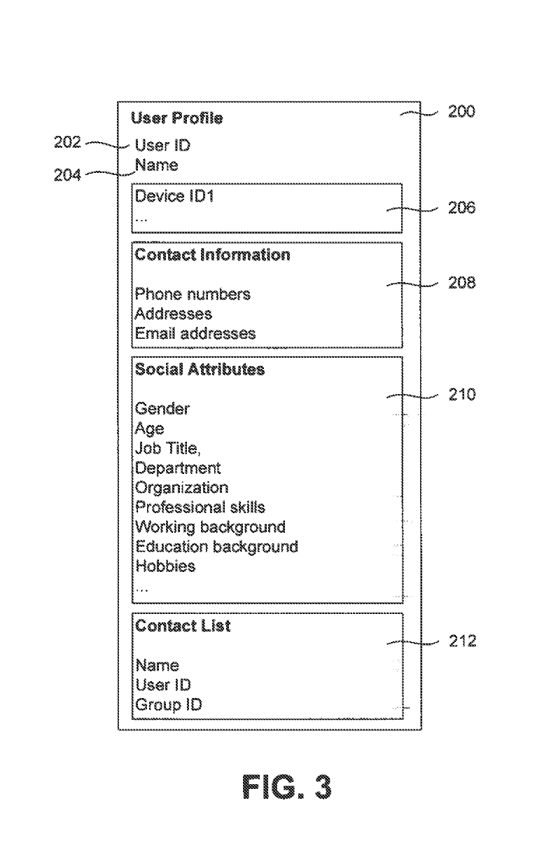

The data acquisition agent 152 sends acquired user related data to the master management module 148. The master management module 148 in turn uses the user related data acquired by the data acquisition agent 152 to populate fields of user profiles of the users 104. FIG. 3 illustrates an exemplary user profile 200 of a user. As shown, user profile 200 comprises a user ID field 202 that holds the unique user ID assigned to the user, a name field 204 that holds the user's name, a device ID field 206 that holds one or more portable computing device IDs associated with the user ID, a contact information field 208 that holds the user's contact details, e.g., phone numbers, addresses, email addresses, etc., a social attributes field 210 that holds user personal information such as for example, gender, age, job title, department, organization, professional skills, working background (e.g., how many years of working experience, former employers, etc.), education background (e.g., degrees the user have, school names, etc.), hobbies, etc., and a contact list field 212 comprising one or more records of other users known to the user.

In this example, each record comprises a contact name field that holds the name of the other user, a user ID field that holds the unique user ID assigned to the other user and a group ID field that holds the name of the group to which the other user has been assigned. In this embodiment, the available groups comprise a “colleagues” group typically reserved for other users who are work associates of the user, a “friends” group typically reserved for other users who are personally known to the user outside of work and an “unknown people” group reserved for users associated with portable computing devices 102 having unrecognized portable computing device IDs. Those of skill in the art will however appreciate that additional or fewer groups may be defined. Each record also comprises an adjustment factor associated with the other user that is used during calculation of a “social metric or index” for the other user as will be described. The adjustment factor typically has a value of zero (0) but may take a non-zero value. The user profile also stores user customizable weighting factors having values between zero (0) and one (1) that are used during calculation of social metrics.

The master management module 148 calculates social metrics upon receipt of requests from portable computing devices 102. Each calculated social metric is a value representing the social relationship between two users and is used during the display of user related information on portable computing devices 102.

Each portable computing device 102 comprises a local database 144 stored on the memory thereof as well as a display module 146 and a local management module 150 running on the processing unit. The local management module 150 communicates with the local database 144 and the display module 146. The local database 144 of each portable computing device 102 caches a display list comprising the user IDs of users associated with recently detected other portable computing devices, profiles of users associated with recently detected other portable computing devices as well as social metrics calculated by the master management module 148 in response to receipt of requests generated by the portable computing device 102. The local management module 150 deployed on each portable computing device 102 receives the portable computing device IDs detected by the identity detector thereof, and searches the local database 144 for information related to the users associated with the detected portable computing device IDs. The local management module 150, if needed, also requests the master management module 148 to search the master database 142 for information related to users associated with the detected portable computing device IDs, and to calculate a social metric for each of the users associated with the received portable computing device IDs. The information received by the local management module 150 from the master management module 148 in response to such a request is sent to the display module 146 for display, and is cached in the local database 144 for further use.

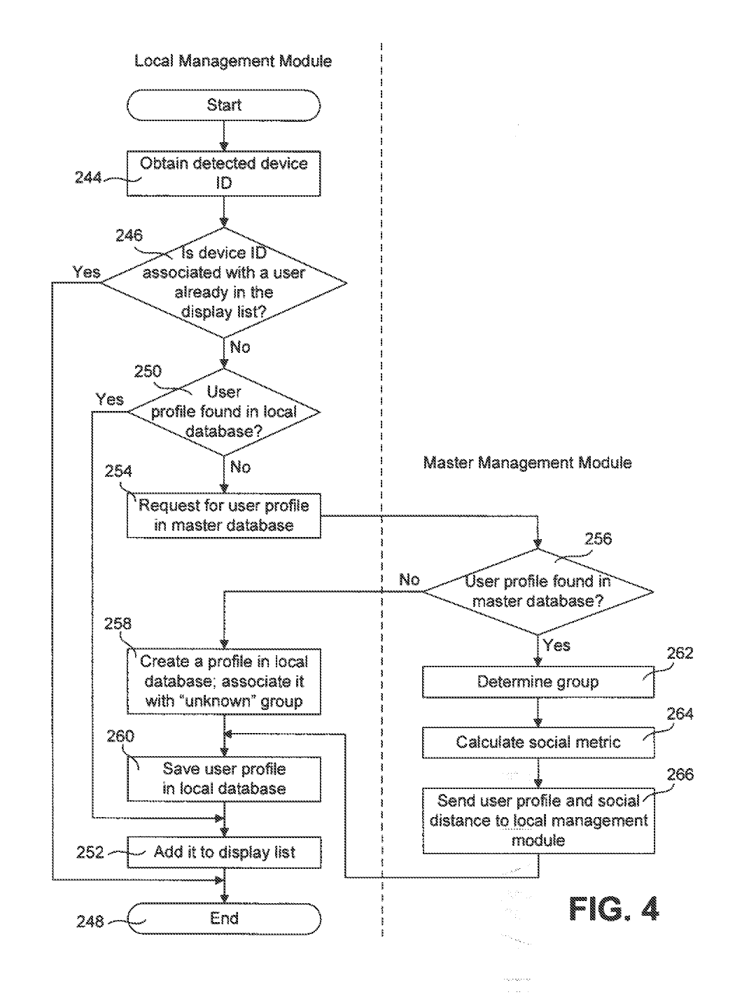

The general operation of the identity detection system 100 will now be described with particular reference to FIG. 4. As mentioned above, the identity detectors of the portable computing devices 102 generally continually search for the existence of identity detectors of other portable computing devices 102 within their communication ranges. When a portable computing device 102 associated with a user (referred to as user A) detects the presence of one or more proximate other portable computing devices 102 associated with other users (referred to as users B) and receives one or more returned portable computing device IDs (step 244), for each received portable computing device ID, the local management module 150 of the portable computing device 102 checks to determine if the received portable computing device ID is associated with a user ID that exists in the display list maintained in its local database 144 (step 246). If the received portable computing device ID is associated with a user ID that exists in the display list, the process then ends (step 248). If the received portable computing device ID is not associated with a user ID that exists in the display list, the local management module 150 searches the local database 144 to identify a user profile having a device ID field populated with the received portable computing device ID (step 250). If such a user profile is found in the local database 144, the user ID in the identified user profile is then added to the display list (step 252) and the process ends (step 248).

If at step 250, no such user profile is found in the local database 144, the local management module 150 of the portable computing device 102 sends a user profile request over the network 110 to the master management module 148 that includes the received portable computing device ID (step 254). Upon receipt, the master management module 148 searches the master database 142 to identify a user profile having a device ID field populated with the received portable computing device ID. If no such user profile is identified in the master database 142, the master management module 148 returns an unknown user response to the portable computing device 102. If such a user profile is identified in the master database 142, the master management module 148 returns the identified user profile to the portable computing device 102. At step 256, if the local management module 150 of the portable computing device 102 receives the unknown user response, or if the local management module 150 of the portable computing device 102 does not receive any response from the master management module 148 within a predefined time period, the local management module 150 of the portable computing device 102 creates a user profile for the portable computing device ID received from the detected portable computing device 102 of the unknown user B. Unknown user B is then assigned to the “unknown people” group (step 258). The created user profile for unknown user B is then stored in the local database 144 of user A's portable computing device (step 260), the user ID of the created user profile is added to the display list (step 252) and the process ends 248.

At step 256, if a user profile having a device ID field populated with the received portable computing device ID is identified in the master database 142, the master management module 148 then examines the profile of the user A associated with the portable computing device 102 to determine if a record for the identified user B exists in the contact list field 212 and if so, the group to which identified user B has been assigned (step 262). At this step, if no record exists, or if a record for identified user B exists but the group ID field is blank, the master management module 148 checks to determine if identified user B could be assigned to user A's “colleagues” group. That is, the master management module 148 compares the organization of the identified user B with that of user A of the portable computing device 102. If the users are within the same organization, the master management module 148 assigns the identified user B to user A's “colleagues” group. If users A and B are not within the same organization, the master management module 148 does not assign identified user B to a group.

The master management module 148 then calculates a social index or metric for the identified user B (step 264). The social metric is a measure of the social relationship between the users A and B and is based on commonalities or similarities and/or interactions of the users. In this embodiment, the social metric is calculated based on a comparison of social attributes in the profiles of the users A and B, the history of communications between the users A and B, and the adjustment factor determined by user A, according to:

D_{A,B}=(a₁P_{A,B}+a₂F_{A,B}+a₃V_{A,B}+a₄J_{A,B})/(a₁+a₂+a₃+a₄),

where:
D_{A,B} is the social metric for the users (A and B);
P_{A,B} is a profile index between the users A and B;
F_{A,B} is the frequency of communication between the users A and B;
V_{A,B} is the frequency with which user A views the profile of user B;
J_{A,B} is the adjustment factor, which is by default equal to 0 until changed; and
a₁, a₂, a₃, a₄ are the user customizable weighting factors taking values between zero (0) and one (1) inclusive.

During calculation of the profile index P_{A,B}, the master management module 148 first assigns a numeric value within a predefined range to each social attribute in the profiles of users A and B, according to a selected quantization scheme. For example, according to one exemplary quantization scheme for a software development organization, a user's job title is assigned a numeric value between zero (0) and ten (10) with the numeric value 0 being assigned to a junior level software developer and the numeric value 10 being assigned in the CEO of the organization. After assigning numeric values to each social attribute in the user profiles, the master management module 148 calculates the profile index P_{A,B} according to:

$${P}_{A , B} = ( {Σ}_{i} {b}_{i} ( 1 - \vert {S}_{A} [ i ] - {S}_{B} [ i ] \vert \text{/} ( MAX [ i ] - MIN [ i ] ) ) \text{/} ( {Σ}_{i} {b}_{i} ) ,$$

where:
MAX[i] and MIN[i] are the maximum and minimum values, respectively, of the range for the i-th social attribute;
S_{A}[i] is the value assigned to the i-th social attribute of user A;
S_{B}[i] is the value assigned to the i-th social attribute of user B;
bᵢ is the i-th weighting factor; and
|x| represents the absolute value of x.

The frequency of communication between users A and B, F_{A,B}, is calculated by the master management module 148 based on the number of times that the two users communicate via all digital communication means monitored by the data acquisition agent 152, including, e.g., emails, instant messages, phone calls initiated from or received by cellular phones and digital phones, messages via short message service (SMS) etc., according to:

$${F}_{A , B} = ( {\sum }_{i = 1}^{N} {w}_{i} {C}_{A , B} [ i ] \text{/} {C}_{A} [ i ] ) \text{/} ( {\sum }_{i = 1}^{N} {w}_{i} ) ,$$

where
C_{A}[i] is the total number of times user A communicated with other people during the i-th past time period;
C_{A,B}[i] is the number of times user A communicated with user B during the i-th past time period; and
wᵢ is the i-th weighting factor.
Each past time period is a predefined time period (e.g., a month) in the past starting from the current date. For example, C_{A}[1] is the total number of times user A communicated with other users during the last month. N (e.g., 12) of such past time periods are counted in the calculation of F_{A,B}. In this embodiment, weight factors w, are predefined such that recent communications are weighted with larger weight factors.

The frequency with which user A views the profile of user B, V_{A,B} is calculated by the master management module 148 according to:

$${V}_{A , B} = ( {\sum }_{i = 1}^{M} {u}_{i} {R}_{A , B} [ i ] \text{/} {R}_{A} [ i ] ) \text{/} ( {\sum }_{i = 1}^{M} {u}_{i} ) ,$$

where
R_{A}[i] is the total number of times user A reviewed the profiles of other users during the i-th past time period;
R_{A,B}[i] is the number of times user A reviewed the profile of user B during the i-th past time period; and
uᵢ is the i-th weighting factor.
Each past time period is a predefined time period (e.g., a month) in the past starting from the current date, which, as will be appreciated by those skilled in the art, may or may not be the same as that in calculation of F_{A,B} in different embodiments. M (e.g., 12) of such past time periods are counted in the calculation of V_{A,B}. In this embodiment, weight factors uᵢ are predefined such that recent reviews of user profiles are weighted with larger weight factors.

The social metric D_{A,B} as calculated above thus measures the social relationship or “closeness” of users A and B. A larger social metric D_{A,B} indicates that user B has a more similar background to user A and/or user A is more interested in communicating with user B. A smaller social metric D_{A,B} implies that users A and B have less in common and user A may not want to have more communication with user B.

Once the social metric has been calculated, the master management module 148 sends the calculated social metric and the identified profile of user B to the portable computing device of user A (step 266). The local management module 150 of the portable computing device 102 in turn saves the user profile and social metric in the local database 144 (step 260) and adds the user ID associated with the user profile to the display list (step 252) before the process ends (step 248).

The local database 144 on each portable computing device 102 is periodically synchronized with the master database 142 to update user profiles. Synchronization may be initiated by the local management modules 150 of the portable computing devices 102 automatically at regular intervals or in response to user input or may be initiated by the master management module 148. During synchronization of the local database of a portable computing device 102 with the master database 142, each user profile in the local database 144 is matched to a corresponding user profile in the master database 142 having user ID fields 202 populated with the same user ID. For matched user profiles, newer content in user profiles stored in one database is copied to the other database. If a user profile in the local database 144 not associated with the “unknown people” group does not match any user profile in the master database 142, the user profile is then copied to the master database 142 as a new user profile. If a user profile in the local database 144 associated with the “unknown people” group (an “unknown” user profile) comprises a portable computing device ID found in a user profile in the master database 142, the user profile in the local database 144 is then merged to the identified user profile in the master database 142. If an “unknown” user profile in the local database 144 does not match any user profile in the master database 142, the local management module 150 then checks the creation date of the “unknown” user profile. If the creation date of the “unknown” user profile is older than a threshold (e.g., 3 months), the local management module 150 deletes the “unknown” user profile; otherwise, the local management module 150 copies the “unknown” user profile to the master database 142 via the master management module 148. The master management module 148 also periodically checks “unknown” user profiles in the master database 142, and deletes those “unknown” user profiles that are older than a threshold (e.g. 3 months).

The local management module 150 also periodically checks to determine if portable computing devices 102 associated with users having assigned unique user IDs that are held in the display list have been recently detected. If a portable computing device 102 associated with a user having a user ID in the display list has not been detected for a predefined period of time, the user ID is then deleted from the display list.

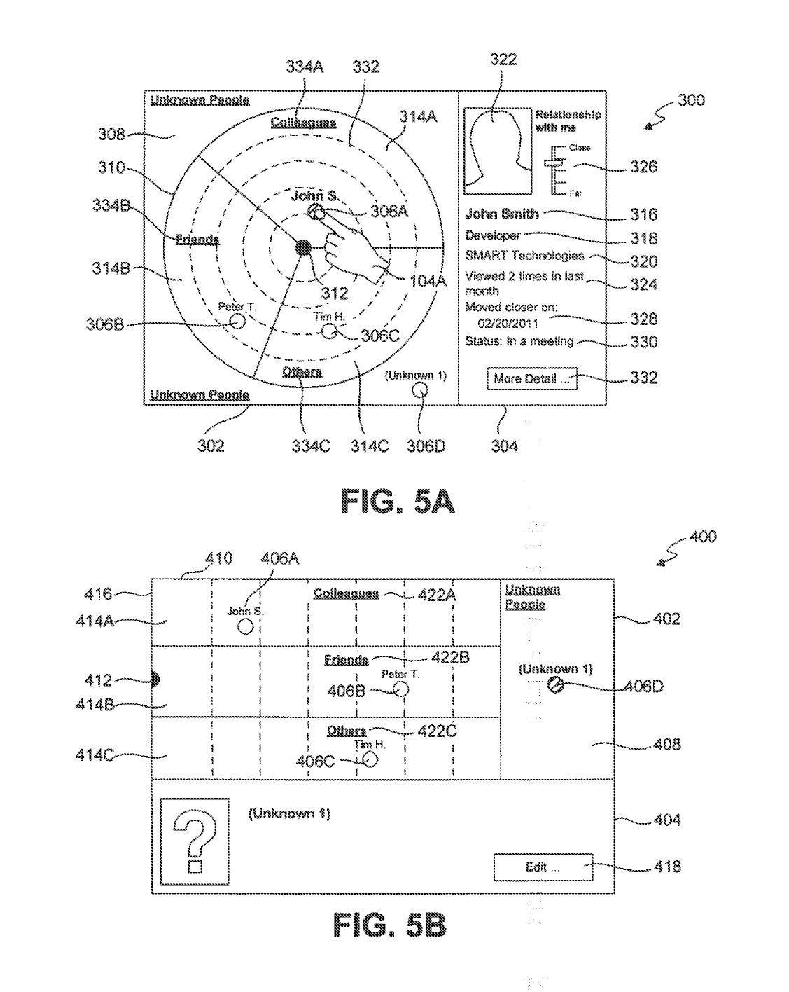

User A of the portable computing device 102 may initiate a command via a user interface (UI) presented by the display screen 102A of the portable computing device 102 to view information relating to other users B associated with detected portable computing devices 102. FIG. 5A illustrates an exemplary UI 300 presented on the display screen 102A of a portable computing device 102. The UI 300 comprises a social map 302 and a user profile zone 304. The social map 302 comprises a zone 308 in which unknown users associated with detected portable computing devices 102 are identified and a zone 310 that is overlaid on a polar coordinate system in which known users associated with detected portable computing devices are identified. The origin 312 of the polar coordinate system displayed in 310 represents user A of the portable computing device 102. The zone 310 is partitioned into multiple sectors 314A to 314C based on the available groups (except the “unknown people” group) that have been set up for user A. In this example, the zone 310 is partitioned into three sectors, namely sector 314A representing the “colleagues” group, sector 314B representing the “friends” group and sector 314C representing known users associated with detected personal computing devices that have not been assigned to any group.

In this example, four (4) other users 306A to 306D are represented by icons on the UI 300. Users 306A to 306C are known people and are represented by icons that are located in the zone 310. User 306D is an unknown person and is identified by an icon located in the zone 308. The position of each icon representing a known person relative to the origin 312 is a function of the social metric calculated for the known person. In particular, for large social metrics, the icons representing known other people are positioned closer to the origin 312, while for smaller social metrics, the icons representing known other people are positioned further from the origin 312. For example, in FIG. 5A the icon representing user 306A is labelled as John S. and is presented in the colleagues sector 314A signifying that the user 306A has been assigned to user A's colleague group. The proximity of the icon representing user 306A to the origin 312 signifies that the social metric calculated for user 306A has a large value. This implies that the users have a strong social relationship, in this embodiment meaning that the users share many commonalities or interests and/or communicate with one another frequently. The icon representing user 306B is labelled as Peter T. and is presented in the friends sector 314B signifying that user 306B has been assigned to user A's friends group. The separation of the icon representing user 306B from the origin 312 signifies that the social metric calculated for user 306B is smaller. This implies that the users have a weaker social relationship, in this embodiment meaning that the users share few commonalities or interests and/or communicate with one another infrequently. The icon representing user 306C is displayed in sector 314C signifying that the user 306C has not been assigned to any of user A's groups. The position of the icon representing user 306C signifies that the social metric calculated for user 306C is small. The grid of circles 332 in the social map 310 allows user A of the portable computing device 102 to estimate the social metrics calculated for detected other users.

The touch sensitive display screen 102A of the portable computing device 102 allows the user A to interact with the UI. In this case, the user may touch the icon representing another user that is displayed on the social map 302 to view that other user's profile. In FIG. 5A, the user A has touched the icon representing user 306A that is displayed on the social map 302. As a result, the icon representing the user 306A is highlighted, and some basic information from that user's profile is shown in the user profile zone 304 including, e.g., the user's name 316, job title 318, organization 320 and picture 322 and the number of times user A of the portable computing device 102 has viewed this user's profile in the most recent past time period 324. A “More Detail” button 332 can be selected to allow additional user profile information to be viewed in the user profile zone 304 such as for example, detailed personal information, resume, schedule, communications with the user of the portable computing device, etc. Those skilled in the art will appreciate that based on privacy setting deployed in the system 100, some profile information of the other user 306A may remain concealed.

The user A of the portable computing device 102 may manually move an icon representing another user from one sector to another sector to change the group to which the other user associated with the icon has been assigned by selecting and dragging the icon. When this occurs, the local management module 150 updates the record in the contact list field 212 of user A's profile associated with the other user to reflect the new group assigned by user. The user A of the portable computing device 102 may also manually change the social metric calculated for another user by selecting and dragging the icon representing the other user either closer to or farther away from the origin 312. When the icon representing another user is dragged closer to the origin 312, the value of the social metric D_{A,B} becomes larger and when the icon representing the other user is dragged further away from the origin 312, the value of the social metric becomes smaller. In response to a manual change of a social metric, the local management module 150 updates the adjustment factor J_{A,B} for the user associated with the moved icon based on the difference between the former and new icon positions relative to the origin 312 and saves the adjustment factor to the local database 144. During synchronization of the master and local databases 142 and 144, the adjustment factor is saved to the master database.

Alternatively, the user A may move a slider 326, presented on the UI to adjust the value of the social metric D_{A,B} associated with the other user whose profile is displayed in the user profile zone 304. In response to movement of the slider 326, the local management module 150 updates the adjustment factor for the other user based on the change in slider position and saves the adjustment factor to the local database. Similarly during synchronization of the master and local databases 142 and 144, the adjustment factor is saved to the master database. The date of the most recent social metric update is also shown in the user profile zone 304, as indicated by the reference numeral 328 together with the status of the other user as indicated by the reference numeral 330.

In this embodiment, each sector 314A to 314C is labelled with a corresponding title 334A to 334C. The user A may select and drag a title towards or away from the origin 312 to adjust the social metric calculated for each user represented by an icon that appears in the sector associated with the dragged title. When a title is selected and dragged, all icons representing users in the corresponding sector are moved towards or away from the origin 312 by an amount corresponding to the change in position of the title. Consequently, the social metrics calculated for the users represented by the icons are adjusted and the adjustment factors associated with those users updated accordingly.

FIG. 5B illustrates an alternative UI 400 presented on the display screen 102A of the portable computing device 102. The UI 400 in this embodiment also comprises a social map 402 and a user profile zone 404. The social map 402 is divided into a zone 408 in which unknown users associated with detected portable computing devices 102 are identified and a zone 410 in which known users associated with detected portable computing devices 102 are identified. The zone 410 is overlaid on a Cartesian coordinate system. A dot 412 at the left edge 416 of the Cartesian coordinate system on zone 410 represents the user A of the portable computing device 102. The zone 410 is partitioned into multiple rows 414A to 414C using the Cartesian coordinate system based on the available groups (except the unknown people group) that have been set up for the user. In this example, the zone 410 is partitioned into three rows namely, row 414A representing the “colleagues” group, row 414B representing the “friends” group, and row 414C representing known people associated with detected portable computing devices that have not assigned to any of user A's groups. Unknown users 406D are shown in the zone 408. The distance between an icon representing another user and the left edge 416 of the Cartesian coordinate system is determined by the value of the social metric D_{A,B} calculated for the other user such that the icon representing the other user will be positioned closer to the left edge 416 of the Cartesian coordinate system if the value of the social metric D_{A,B} is larger. The user A of the portable computing device 102 may drag the icon representing another user into a different row to reassign that user to a different group. The user of the portable computing device may also drag the icon representing another user towards or away from the left edge 416 to change the social metric calculated for that other user as described above.

In this embodiment, each row 414A to 414C is labelled with a corresponding title 422A to 422C. The user A may select and drag a title towards or away from the left edge 416 to adjust the social metric for all users represented by icons appearing in the row associated with the dragged title. When a title is selected and dragged, all icons representing other users in the corresponding row are moved towards or away from the left edge 416. Consequently, the social metrics for the other users are adjusted in the manner described above.

The user A of the portable computing device 102 may select an icon representing another user to view that user's profile. For example, in FIG. 5B, the user A of the portable computing device 102 has selected the icon representing unknown user 406D shown in zone 408. In response, an “Edit” button 418 is displayed in the user profile zone 404, allowing the user A of the portable computing device 102 to manually input information regarding the unknown user.

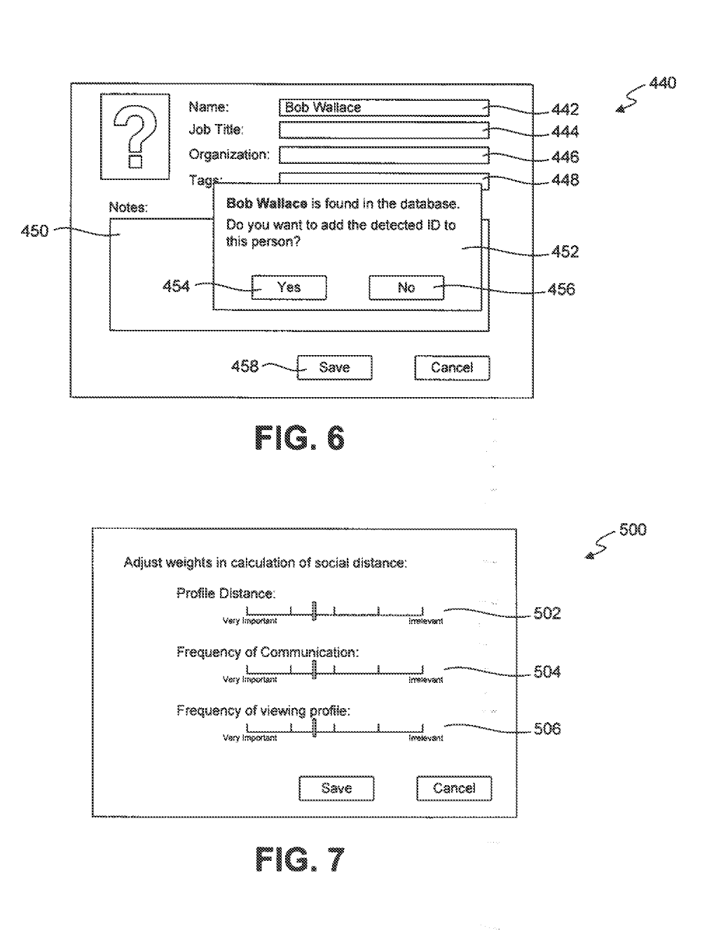

FIG. 6 illustrates a UI 440 that is presented on the display screen 102A of the portable computing device 102 that allows user A thereof to edit the user profile of an unknown user. The user A of the portable computing device 102 may enter the name of the unknown user in the text box 442. After the name has been entered, the local management module 150 searches the user profiles in the local database 144 to locate a user profile having a name field populated with the entered name. If a user profile is found, a dialogue box 452 is displayed asking whether the user A wants to associate the unknown user to the user profile found in the local database 144. The user A of the portable computing device 102 may touch the “Yes” button 454 to associate the unknown user to the user profile. In this case, the local management module 150 populates fields 444 to 450 of the UI 440 using information in the identified user profile. After the user A of the portable computing device 102 saves the modification by selecting the “Save” button 458, the social metric for the former unknown user is retrieved from the local database 144 and the icon representing the former unknown user is removed from the unknown people group and moved to the “others” zone of the social map at a position corresponding to the social metric retrieved from the local database 144.

Alternatively, the user may select the “No” button 456, and manually populate the fields of the user profile such as for example, job title 444, organization 446, tags 448 and description 450. After the user profile has been populated, the updated user profile can be saved by selecting the “Save” button 458. Thereafter, the social metric of the updated user profile is assigned with a minimum value (e.g., zero(0)), and the icon representing the former unknown user is removed from the unknown people group, and moved to the others zone of the social map.

During the search of the local database 144, if no user profile is found, the local management module 150 sends a search request to the master management module 148. In response, the master management module 148 performs a similar search of the master database 142. If the master management module 148 locates a user profile, a social metric for the other user is calculated in the manner described previously. The user profile and the calculated social metric are then returned to the portable computing device 102. The dialogue box 452 is then displayed asking whether user A of the portable computing device 102 wants to associate the unknown user to the returned user profile. If the master management module 148 does not locate a user profile, the user of the portable computing device is only given the option of populating the fields manually.

Users of portable computing devices 102 are also able to adjust various settings to allow the calculation of social metrics and the display of icons representing detected other users to be customized. FIG. 7 shows a UI 500 presented on the display screen 102A of a portable computing device that enables user A thereof to customize the calculation of social metrics. The user A of the portable computing device may use sliders 502, 504 and 506, respectively, to adjust the weighting factors of profile distance P_{A,B}, frequency of communication F_{A,B} and frequency of viewing profile V_{A,B} that are used during the calculation of the social metrics D_{A,B}.

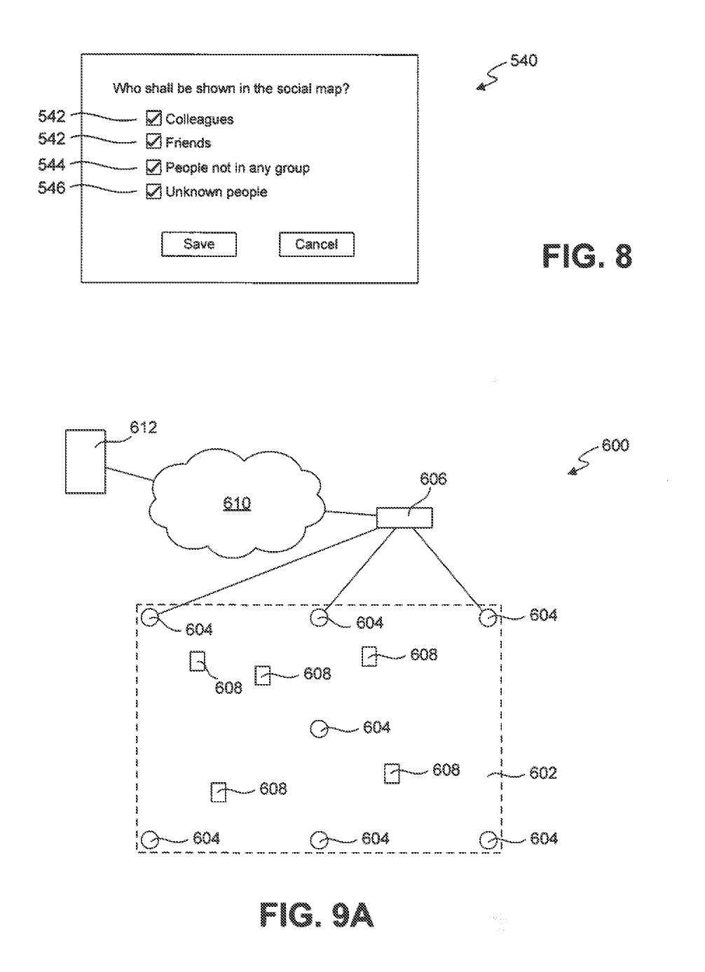

FIG. 8 shows a UI 540 presented on the display screen 102A of a portable computing device 102 that enables the user A thereof to customize the display of other users associated with detected portable computing devices. The UI 540 lists all available groups 542 that have been set up, as well as “users not in any group” 544 and “unknown people” 546. A check box that is checked by default is associated with each entity in the list. The user A of the portable computing device 102 may deselect one or more of the entities 542 to 546 in the list. Deselected entities are not shown in the social map. If the “users not in any group” entity 544 is deselected, the “Others” sector 314C in FIG. 5A or the “Others” row 422C in FIG. 5B is not shown on the social map. Also, icons representing other users associated with detected portable computing devices 102 that fall into this group are also not shown on the social map. If the “unknown people” entity 546 is deselected, the zone 308 (in FIG. 5A) or zone 408 (in FIG. 5B) is not shown, and the entire area of the social map is used to display the coordinate system.

In an alternative embodiment, each portable computing device 102 monitors the schedule of the associated user A and provides suggestions regarding the possible identity of unknown people associated with detected portable computing devices 102. In this embodiment, the local management module 150, with the help of the master management module 148, retrieves the schedule of the associated user A. If the schedule of the associated user indicates that user is currently in a scheduled event, the local management module 150 then retrieves the list of participants of the event, and compares the names in the participant list with user profiles to identify other users. Unknown people associated with portable computing devices 102 detected may be people in the participant list that do not match any detected users. A suggestion of the identities of unknown detected other users is then provided to user A of the portable computing device 102.

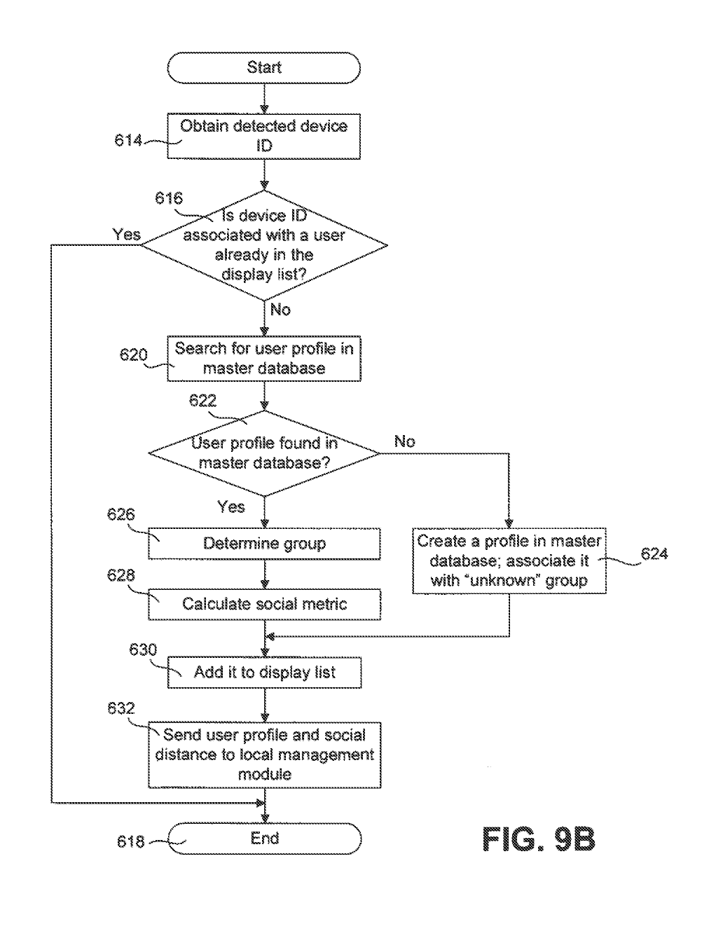

FIG. 9A illustrates an alternative user identity detection system 600. In this embodiment, the user identity detection system 600 comprises a plurality of wireless devices 604 deployed in a site 602, such as for example, a building or a meeting room. The wireless devices 604 are connected to a wireless controller 606, which is also connected to a network 610. In this embodiment, the wireless devices 604 are lightweight access points (APs), such as Cisco Wireless Location Appliances (e.g., model 2710) offered by Cisco Systems, Inc., San Jose, Calif., U.S.A. A server 612 having a master database and a data acquisition agent running thereon is also connected to the network 610.

One or more portable computing devices 608 in site 602 are wirelessly connected to the APs 604 allowing the portable computing devices to access the network 610 and communicate with the server 612. The wireless controller 606 controls the APs 604 to provide network access to the portable computing devices 608, and tracks the location of each portable computing device 608 using WiFi triangulation.

The system architecture is similar to that shown in FIG. 2 except the local database 144 is optional and thus may not be implemented. Each portable computing device 608 comprises a unique device ID, e.g., its media access control (MAC) address, which is associated with the user ID of its associated user. Each user has an associated user profile that is stored in the master database 142 of server 612 as described previously. In this embodiment, the portable computing devices 608 do not comprise ID detectors. The master management module 148 of server 612 obtains, via the data acquisition agent 152, the location of each portable computing device 608 from the wireless controller 606, and associates the location information to the profile of its associated user. Then, the master management module 148 sends the user profiles as well as the location information to the local management module 150 on each portable computing device 608.

The process of detecting a device ID and the identification of the user ID associated therewith is similar to that shown in FIG. 4. In this embodiment, the master management module 148 maintains a display list, which is in synchronization with the display list on each computing portable device 608. During operation, when the master management module obtains a detected device ID (see step 614 in FIG. 9B), the master management module checks to detect if the detected device ID is associated with a user ID in the display list (step 616). If the detected device ID is associated with a user ID in the display list, the process ends (step 618).

If at step 616, the detected device ID is not associated with a user ID in the display list, the master management module 148 searches the master database 142 for a user profile having a device ID field populated with the detected device ID (step 620). At step 622 no such a user profile is found, the master management module 148 then creates a user profile in which the device ID field is populated with the detected device ID, and which is associated with the unknown people group (step 624). The user ID of the new user profile is then added to the display list (step 630).

If at step 622, a user profile having a device ID field populated with the detected device ID is found in the master database 142, the master management module 148 then determines the group to which the user associated with the user profile has been assigned (step 626) as described above, and calculates the social metric for the users (step 628). The detected user profile, together with the calculated social metric, is then added to the display list (step 630), and is sent to the local management module 150 of each portable computing device 102 for display (step 632).

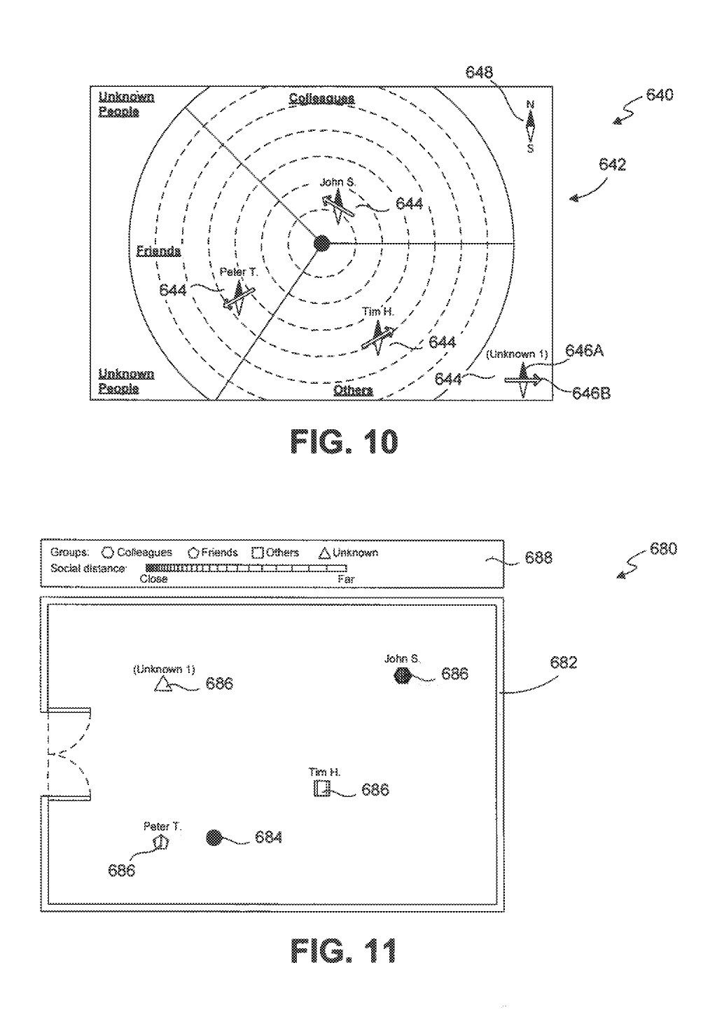

The social map presented on the display screen of each portable computing device includes location information of the users in the site 602. FIG. 10 illustrates a UI 640 presented on the display screen of a portable computing device 608 showing a social map 642. The social map 642 is similar to that shown in FIG. 5A. However, in this embodiment, the icon 644 representing each detected user comprises a reference direction indicator 646A and a user direction indicator 646B indicating the direction of the detected user with respect to the reference direction. A legend icon 648 is also shown in the social map identifying the direction of the reference direction. The user of the portable computing device 608 may select the icon representing another user to view that user's profile (not shown).

FIG. 11 illustrates a UI 680 showing the floor plan 682 of the site 602 presented on the display screen of the portable computing device. The local management module 148, using the location information provided by the master management module, presents an icon 684 representing the user associated with the portable computing device 608 and icons representing other detected users 686 at the locations in the floor plan corresponding to their location information. Here, the icons representing other detected users are of different shapes to represent the different groups to which the users are assigned, and are of different color- or grey-scale-gradients to indicate the social metrics calculated for the other detected users 686. Legends 688 are also shown above the floor plan 682.

Similar to the previous embodiment, the user of the portable computing device 608 may touch the icon representing a detected user displayed on the social map or floor plan to view the user's profile. When viewing a user profile, the user of the portable computing device 608 may attach a note to the user profile, and set up a reminder regarding the user associated with the profile being viewed on the portable computing device 608. Then, when the master management module determines that the user associated with the reminder is within a user customizable distance to the user of the portable computing device 608, the reminder is activated to remind the user A that the other user is coming, and that a note attached to profile of that user needs to be reviewed.

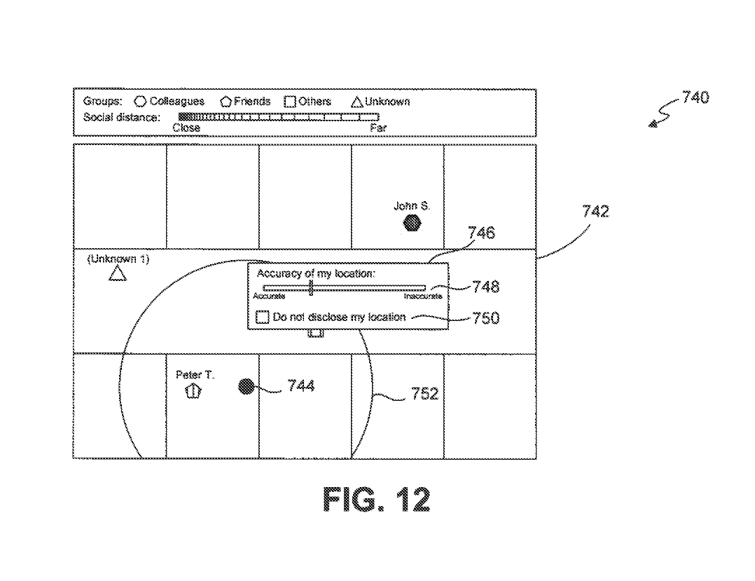

In another embodiment, the system provides a privacy control mechanism to allow each user to customize the level (e.g., all, a part or none) of his/her profile information to be disclosed to other users. The privacy settings may apply to everyone, a group of users or an individual user. Such privacy control mechanisms are well known in the art and will not be described here. In this embodiment, the system also allows each user to customize the accuracy of his/her location information to be disclosed to other users. FIG. 12 illustrates a UI 740 presented on the display screen of a portable computing device 608 that enables the user associated therewith to adjust the accuracy of his/her location information to be disclosed. The UI 740 shows a floor plan 742 of a site (e.g., a building) with the user of the portable computing device 608 being represented by a dot 744. Icons representing other detected users are also shown at their respective detected locations. The user of the portable computing device may touch the dot 744 to pop up a dialogue box 746 for adjusting the location accuracy. Then, user A may move the slider 748 to change the accuracy. A circle 752 centered at the location of the dot 744 is shown to indicate the location accuracy. The circle 752 becomes smaller when user A moves the slider 748 towards the “accurate” end, and becomes larger when user A moves the slider 748 towards the “inaccurate” end. User A may also drag the circle 752 to be centered at another location. After the location accuracy is adjusted, the system, each time when reporting user A's location to another user, will randomly select a location within the circle 752 as user A's location and report it thereto.

User A may alternatively select the checkbox 750 so that his/her location information is not provided to other users. In a related embodiment, user A may set different location accuracy parameters to different users or groups.

The methodologies described above may be embodied in a computer program comprising program modules including routines, object components, data structures and the like and may be embodied as computer-readable program code stored on a non-transitory computer-readable medium. The computer-readable medium is any data storage device. Examples of computer-readable media comprise for example, read-only memory, random-access memory, CD-ROMs, magnetic tape, USB keys, flash drives, optical storage devices, etc. The computer-readable program code can also be distributed over a network including coupled computer systems so that the computer-readable program code is stored and executed in a distributed fashion.

Those skilled in the art will appreciate that various alternative embodiments are readily available. For example, in an alternative embodiment, when the social metric for a user is calculated, different communication methods (e.g., email, instant messages, SMS messages and phone calls) may be differentiated by applying different weighting factors thereto in the calculation of social metric. In a related embodiment, the targeting of communications may also be differentiated by applying different weighting factors thereto. For example, the frequency that user B's name in the “To” field of emails sent by user A may be weighted with a larger weighting factor, and the frequency that user B's name in the “cc” or “bcc” field of emails sent by user A may be weighted with a smaller weighting factor. In yet another related embodiment, the direction of communications may be differentiated by applying different weighting factors to incoming and outgoing communications, respectively.

In another embodiment, the portable computing device of a user A may use the frequency that user A's portable device detects user B's ID in calculating the social metric between users A and B.

Those skilled in the art will appreciate that, in some alternative embodiments, rather than showing a social map, detected users may be listed in a table showing the name, calculated social metric, group, etc. of each detected user, that is presented in a UI. The table may be unsorted, or sorted by name, social metric or group, depending on the choice of the user of the portable device 102.

Those skilled in the art will appreciate that, in some alternative embodiments, other definitions of social metric may be used, and may be calculated by taking into account various information related to user's personality, background and communications. For example, the social metric may be calculated based on the profile distance P_{1,2} only, or may be calculated based on the frequency of communication F_{1,2} only, depending on the system design. As another example, in an alternative embodiment, users are not allowed to adjust social metrics. In still another embodiment, the social metric may be calculated according to:

D_{A,B}=(a₁+a₂+a₃+a₄)/(a₁P_{A,B}+a₂F_{A,B}+a₃V_{A,B}a₄J_{A,B}),

such that a smaller D_{A,B} implies that users A and B are socially “closer” to each other. Those skilled in the art would understand that, here, if the denominator in above equation equals to zero, D_{A,B} equals to a predefined large number without triggering an error.

In yet another embodiment, the user of a portable computing device may search for a user in the (master and/or local) database, and check whether the searched user is detected or not.

Although in the embodiment illustrated in FIG. 9A, portable computing devices 608 do not comprise any identity detector, in an alternative embodiment, at least some portable computing devices comprise an identity detector, such as for example, a Bluetooth device. In this embodiment, the detection of other users by the identity detector may be combined with the location information the portable computing device obtained from the master management module to improve the experience of awareness of other users.

In above embodiments that use Bluetooth devices, the Bluetooth device being scanned (i.e., being detected), after responding with its Bluetooth address and class of device record, reports to the user via a UI displayed on the portable device 102 that the user has been detected by another user.

The Bluetooth devices of users within a mutually detectable range form a local communication network independent to the network 110 (in FIG. 1) or network 610 (in FIG. 9A). In an alternative embodiment, a user A may send a request to another user B for a Bluetooth connection. The local management module 150 on user B's portable computing device then retrieves user A's user profile and social metric thereto, and displays it in a UI having a social map to facilitate user B to decide whether user A's request should be accepted or not.

Although in above embodiments, Bluetooth devices are used as identity detectors, in some alternative embodiments, other identity detectors may also be used. For example, in an alternative embodiment, the identity detector is a radio frequency identity (RFID) detector coupled to the portable computing device to receive the signal of nearly RFID transmitters, and detect the ID thereof. The RFID transmitter may be embedded in the portable computing device, or may be embedded in an RFID badge. In a related embodiment, some users may only carry their RFID badges but may not have a portable computing device.

In still another embodiment, each portable computing device comprises a global navigation satellite system (GNSS) receiver, such as for example, a global positioning system (GPS) receiver, to obtain its location information and report the location information to the master management module.

Although in embodiments described above, the portable computing device comprises a touch screen, in an alternative embodiment, the portable computing device does not comprise a touch screen. Other input means, such as for example, mouse, trackball, touchpad and keyboard, may be used to receive input from the user.

Although in embodiments described above, portable computing devices are used. In some alternative embodiments, other computing devices, such as desktop computers, may also be used. In a related embodiment, at least some users' computing devices in the system may not comprise any ID detector for detecting other user's identity, and the system may not be able to detect at least some users' locations. The network in this embodiment is the Internet.

In this embodiment, a user (user B) may use his/her computing device to send a request to another user (user A). The local management module 150 on user A's computing device then retrieves user B's user profile and social distance thereto, and displays it in a UI having a social map to facilitate user A to decide whether user B's request should be accepted or not.

In still another embodiment, the privacy control may be based on social metrics. A set of user customizable privacy settings for each user is stored in the master database 142, and is cached in the local database 144 of the user's portable computing device. The privacy settings define a plurality of privacy levels regarding what information of the user may be disclosed, and for each privacy level, what social distance threshold must be satisfied in order to share the information regulated in this privacy level. When a user (user B) requests the access of the user profile of user A, the master management module 148 (or user A's local management module 150 if the request is sent from user B directly to user A via the Bluetooth devices) first calculates the social metric for users A and B, and grants user B the access only to the information at levels that the value of the calculated social distance is larger than the social distance threshold defined therein.

Although in above embodiments, the social metrics are calculated by the master management module 148, in an alternative embodiment, the social metrics may be calculated by the local management module 150 of each portable computing device.

Although embodiments have been described above with reference to the accompanying drawings, those of skill in the art will appreciate that variations and modifications may be made without departing from the spirit and scope thereof as defined by the appended claims.

What is claimed is:

1. An information display method comprising:
retrieving, from at least one database, information concerning a user and at least one other user;
calculating a relationship value for the at least one other user, the relationship value being at least partly based on the retrieved information; and
using the relationship value as a factor during the display of information relating to the user and the at least one other user.

2. The method of claim 1 wherein the relationship value is used to determine the position of displayed information relating to the user and the at least one other user.

3. The method of claim 2 wherein the relationship value is used to determine the relative positions of display elements representing the user and the at least one other user.

4. The method of claim 3 wherein the relationship value is at least partly based on the frequency of communications between the user and at least one other user.

5. The method of claim 4 wherein the relationship value is further at least partly based on commonalities and/or similarities between the user and the at least one other user.

6. The method of claim 5 wherein the commonalities and/or similarities are commonalities and/or similarities in social attributes of the user and the at least one other user.

7. The method of claim 6 wherein the commonalities and/or similarities in social attributes are determined by comparing corresponding social attribute fields in profiles of the user and at least one other user stored in the at least one database.

8. The method of claim 7 further comprising quantizing the social attribute fields using at least one quantizing scheme prior to said comparing.

9. The method of claim 6 wherein the relationship valve is further at least partly based on one or more of a user designated adjustment factor and weighting factors.

10. The method of claim 3 wherein when the relationship value is representative of a strong relationship between the user and the at least one other user, the display elements representing the user and the at least one other user are positioned proximate to one another.

11. The method of claim 3 wherein when the relationship value is representative of a weak relationship between the user and the at least one other user, the display elements representing the user and the at least one other user are positioned away from one another.

12. The method of claim 3 wherein the display elements representing the user and at least one other user are presented on a social map, at least the display element representing the at least one other user being manipulatable in response to user input.

13. The method of claim 12 wherein the display element representing the at least one other user is moveable relative to the display element representing the user in response to user input and wherein when the display element representing the at least one other user is moved, the method further comprises recalculating the relationship value based on the new relative positions of the display elements.

14. The method of claim 3 wherein during said retrieving, information concerning the user and at least one other user is retrieved from user profiles stored in the at least one database.

15. The method of claim 14 wherein during said retrieving at least one of local and remote databases are searched to locate user profiles associated with the user and at least one other user.

16. The method of claim 3, wherein the display elements representing the user and at least one other user are presented on a social map, and wherein the social map is partitioned into at least two zones based on defined groups, the zone in which the display element representing the at least one other user is located being based on group data assigned to the at least one other user.

17. The method of claim 16 wherein the group data assigned to the at least one other user is assigned either by the user or by default.

18. The method of claim 3 further comprising:
prior to said retrieving, receiving information concerning said at least other user; and
searching the at least one database to determine the identity of the at least one other user.

19. The method of claim 18 wherein said received information comprises a computing device identification (ID) associated with said at least one other user.

20. An apparatus comprising:
memory; and
processing structure communicating with the memory, the processing structure, executing program code stored in the memory, to cause the apparatus to:
retrieve, from at least one database, information concerning a user and at least one other user;
instruct calculation of a relationship value for the at least one other user, the relationship value being at least partly based on the retrieved information; and
use the relationship value as a factor during the display of information relating to the user and the at least one other user.

21. An apparatus according to claim 20 wherein the relationship value is used to determine the position of displayed information relating to the user and the at least one other user.

22. An apparatus according to claim 21 wherein the relationship value is used to determine the relative positions of display elements representing the user and the at least one other user.

23. An apparatus according to claim 22 wherein the relationship value is at least partly based on the frequency of communications between the user and at least one other user.

24. An apparatus according to claim 23 wherein the relationship value is further at least partly based on commonalities and/or similarities between the user and the at least one other user.

25. An apparatus according to claim 24 wherein the commonalities and/or similarities are commonalities and/or similarities in social attributes of the user and the at least one other user.

26. An apparatus according to claim 25 wherein the commonalities and/or similarities in social attributes are determined by comparing corresponding social attribute fields in profiles of the user and at least one other user stored in the at least one database.

27. An apparatus according to claim 24 wherein the relationship valve is further at least partly based on one or more of a user designated adjustment factor and weighting factors.

28. An apparatus according to claim 24 wherein when the relationship value is representative of a strong relationship between the user and the at least one other user, the display elements representing the user and the at least one other user are positioned proximate to one another.

29. An apparatus according to claim 24 wherein when the relationship value is representative of a weak relationship between the user and the at least one other user, the display elements representing the user and the at least one other user are positioned away from one another.

30. An apparatus according to claim 24 wherein the display elements representing the user and at least one other user are presented on a social map, at least the display element representing the at least one other user being manipulatable in response to user input.

31. A server configured to receive, from at least one database, information concerning a user and at least one other user, calculate a relationship value for the at least one other user with the relationship value being at least partly based on the retrieved information and transmit the calculated relationship value to a portable computing device for use as a factor during the display of information relating to the user and the at least one other user on the portable computing device.
